(19) United States
(12) Patent Application Publication
(10) Pub. No.: US 2014/0076818 A1
(43) Pub. Date: Mar. 20, 2014

(54) Method and apparatus for magnetic activation of water based solutions and materials

(71) Applicant: Douglas Benjamin Kankiewicz, Longmont, CO (US)

(72) Inventor: Douglas Benjamin Kankiewicz, Longmont, CO (US)

(21) Appl. No.: 14/020,865

(22) Filed: Sep. 8, 2013

Related U.S. Application Data
(60) Provisional application No. 61/701,653, filed on Sep. 15, 2012.

(51) Int. Cl. C02F 1/48

(52) U.S. Cl. CPC C02F 1/481
USPC 210/695; 210/222; 210/175

(57) ABSTRACT

A device for crystalline-enhanced magnetic activation of water and aqueous materials includes a target material container, a crystalline material, an optional conductive metal layer, and a magnet, whereby a target material can be activated by the magnetic field, which radiates through the crystalline material and the conductive metal layer. A method for magnetic activation includes exposing a target material to a magnetic field, while heating the target material, then subsequently cooling the target material to an ambient temperature, and finally actively cooling the target material. Also disclosed is a method to replicate a natural water source, comprising analyzing a natural water source, adding minerals to pure water, heating the re-mineralized pure water, cooling the target material water, while the target material water is exposed to a crystalline-enhanced magnetic field.

### CROSS-REFERENCE TO RELATED APPLICATIONS

This application claims the benefit of U.S. Provisional Application No. 61/701,653, filed Sep. 15, 2012.

### FIELD OF THE INVENTION

The present invention relates generally to the field of activation of water or aqueous substances in the presence of a magnetic field.

### BACKGROUND OF THE INVENTION

Purification and other improvements of water quality remains a topic of great interest, and a number of technologies have been developed to improve the quality of water for domestic or industrial use.

It is well known that water and aqueous substances can be activated in a magnetic field, and thereby gain various improved properties, for example related to reducing deposits of scales and reducing bacterial growth.

While the exact mechanisms of operation remain unknown, and some applications may still be considered controversial, leading researchers have proposed a number of hypotheses for particular applications of magnetic water treatment, for example:
a. That the shapes of solute lime molecules are modified by strong magnetic fields, leading them to precipitate as spherical or round crystals rather than deposit as sheets or platelets of hard crystals
   (“Interview of Klaus Kronenberg, Ph. D”. GMX International, 2012-03-26, http://www.gmxinternational.com/facts/interview/)
b. That the crucial step is the interruption of agglomeration of particles carrying a surface charge after dissolved contaminants have nucleated as a colloidal suspension.
   (John Donaldson, professor of chemistry at Brunel University, “A problem of scale. (Water conditioning)”. Entrepreneur.com, 1996-04-01)
c. That the magnetic field reduces the surface charge on small particles, increasing the tendency to coagulate as large particles that stay with the flow rather than depositing as scale.
   (Simon Parsons of the School of Water Sciences, Cranfield University, “A problem of scale. (Water conditioning)”. Entrepreneur.com, 1996-04-01)

Magnetic treatment of water and aqueous substances remains an active area of research and development, as for example evidenced by the following:
a. Recently published research demonstrates that magnetic treatment causes water containing minerals to favor formation of a more soluble form of calcium carbonate (aragonite rather than calcite), thereby causing a resulting removal of calcium carbonate deposits from a steel substrate. (Coey, J M D; Cass, S (2000). “Magnetic water treatment”. Journal of Magnetism and Magnetic Materials 209: 71-74)
b. A 2003 paper concludes that the effects of magnetic treatment on water indeed results in reduced formation of lime scale and that this effect lasts approximately 200 hours.
   (Kozic, V; Lipus, L C (2003). “Magnetic water treatment for a less tenacious scale”. Journal of Chemical Information and Computer Sciences 43 (6): 1815-9)
c. U.S. Pat. No. 4,888,113, describes a magnetic device which can be clamped on to a water pipe, in order to produce various beneficial effects, including, reduction of the formation of deposits on the inside of water pipes, improving the taste, and reducing surface tension.
d. U.S. Pat. No. 7,641,793 describes a series of magnets arranged around a container, whereby the flavor of a beverage can be enhanced, and water can be more effectively absorbed by a person's body.
e. U.S. Pat. No. 5,113,751 discloses a device for enhancing beverage brewing by water treatment involving magnetic treatment, and optionally a warming systems for brewed beverages.

A number of other patents have been issued in the general area of magnetic treatment of water and aqueous substances, which remains an active area of research. As such, it may be appreciated that there continues to be a need for novel and improved methods and devices for magnetic treatment of aqueous substances.

### SUMMARY OF THE INVENTION

The foregoing needs are met, to a great extent, by the present invention, wherein in aspects of this invention, enhancements are provided to the existing model of magnetic activation and treatment of water and aqueous materials.

In various aspects of the invention, aqueous liquids or materials, including water, can be transformed, or magnetically activated, utilizing enhanced magnetic field processes and devices.

Aqueous liquids, when activated with the methods and devices developed in accordance with the various aspects of the invention described and claimed herein, develop distinctively enhanced properties, which are beneficial in numerous chemical and biological processes, in which the activated liquids can be used in place of some or all of the normal water or liquid supply.

Enhancement can be demonstrated by improved results from experiments, as compared to the same experiments, when performed with other well-known magnetic field activated water or material activating devices. For example, various aspects of this invention have been used successfully to reduce alkalinity, acidity or hardness of water, enhance the flavor of beverages, enhance the flavor of mineral or tap water, reduce the bacterial content of contaminated water, and enhance the growth rate and viability of plants.

There is also limited indication that ingesting activated water, or being in proximity of devices implementing aspects of this invention, may have advantageous physiological effects on mammals, including but not limited to treatment of viral infections and other bodily ailments.

When devices constructed according to aspects of this invention irradiate a body of a target liquid, or other aqueous material, through operation under the conditions of a magnetic field radiated through a crystalline structure, and optionally employing a time-controlled temperature change process, the target material becomes activated. The activated liquid can then be used as a partial or complete substitute for non-activated liquid in numerous industrial chemical and biochemical reactions. Such use has been found to improve the efficiency of a number of such reactions.

In view of the foregoing background, it is therefore an object of the present invention to provide various aspects of a device and method for activating enhanced properties of aqueous materials, by exposing such materials to an enhanced magnetic field with magnetic flux passing through a crystalline structure, and optionally a metal alloy layer.

In aspects of this invention, the target material can be preheated or cooled to a given temperature before or during the activation process, to enhance the activation of the aqueous material, and thereby produce the most beneficial activation effect.

### BRIEF DESCRIPTION OF THE DRAWINGS

FIG. 1 is a cross-sectional centerline elevation view, according to an embodiment of the invention.

FIG. 2 is a cross-sectional centerline elevation view, according to an embodiment of the invention.

FIG. 3 is a cross-sectional centerline elevation view, according to an embodiment of the invention.

FIG. 4 is a cross-sectional centerline elevation view, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

Throughout this disclosure the term crystalline shall be understood to include crystals or crystalline solids, defined as solid materials whose constituent atoms, molecules, or ions are arranged in an ordered pattern extending in all three spatial dimensions. A crystalline material shall be further extended to include materials, which contain a significant amount of crystalline solids, which may be embedded in materials that are not, or only partially, composed of crystalline solids.

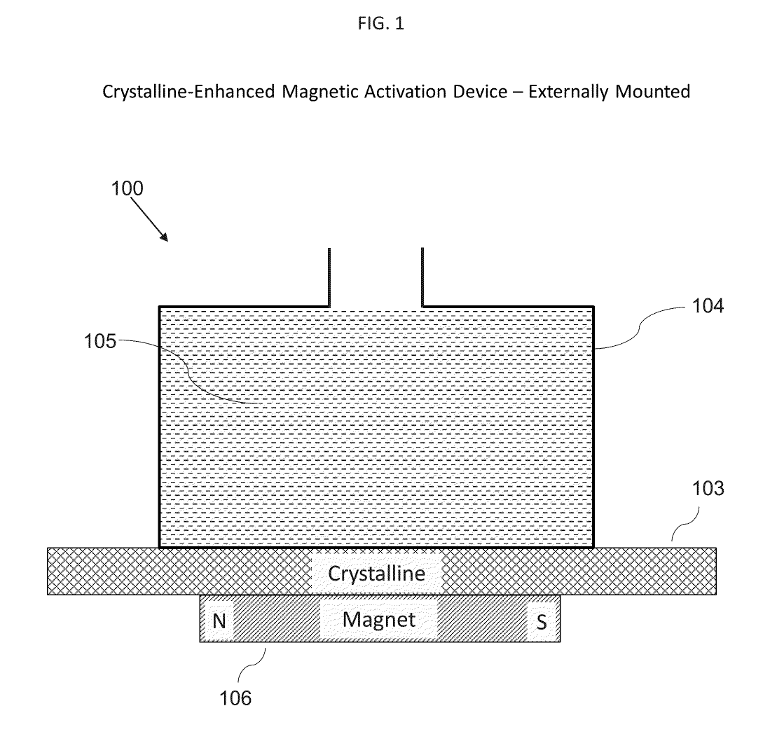

In the following, we describe the structure of an embodiment of the crystalline-enhanced magnetic activation device with reference to FIG. 1, in such manner that like reference numerals refer to like components throughout; a convention that we shall employ for the remainder of this specification.

A crystalline-enhanced magnetic activation device 100 can include
a. a target material container 104,
b. a crystalline material 103, and
c. a magnet 106,
wherein the magnet 106 generates a magnetic field, which radiates through the crystalline material 103, whereby the target material 105, contained in the target material container 104, is activated.

In related embodiments, the target material 105 can include water, aqueous solutions, or aqueous materials, herein included beverages and foods for consumption.

In further related embodiments, the target material 105, can include water-based organic material, including:
a. Plants, vegetables, fruits, legumes, tubers, mushrooms, grains, nuts;
b. Meats, including processed and unprocessed meats for human consumption, and other forms of animal tissue;
c. Organisms, parts of organisms, and manufactures of organisms, wherein the organisms, include plants, animals, fungi or microorganisms;
d. Organic matter, including matter composed from organic compounds that has come from the remains of once-living organisms.

In a related embodiment, the crystalline material 103 can comprise at least one layer or structure, formed in any geometrical shape or size made of a material with a crystalline structure.

In related embodiments, examples of materials for the crystalline material 103 are marble, granite, sandstone, other natural stones, Giallo crystal onyx, chalcedony, onyx, cryptocrystalline, other gemstones, precious and semi-precious stones, and pure crystal materials.

In further related embodiments, the crystalline material 103 can be composed of multiple layers of substantially different crystalline materials. Those layered materials, can further include composite materials with embedded crystalline structures, such as for example concrete cured cement with natural stones, minerals or resin, polymers, epoxy based hardened stone structures with naturally grown or fabricated crystals structures, composed of different crystal sizes, mixtures and ratios of minerals, etc.

In related embodiments, the magnet 106, can include
a. a permanent magnet, made of various suitable materials that are known by persons of ordinary skill in the art;
b. a direct current electromagnet;
c. an alternating current electromagnet; or
d. other magnetic structures, which induce a static or fluctuating magnetic field.

In related embodiments, examples of permanent magnet material for the magnet 106 can be ceramic, rare earth, or any other permanent magnet material that can generate a magnetic field of sufficient strength to activate a given size or volume of the said materials, etc.

In related embodiments, depending on the application, an effective magnetic field of sufficient strength can be a static or fluctuating field of a strength that normally falls substantially within an effective range of 100 to 20,000 Gauss throughout the volume of the target container 104.

In related embodiments, the magnet 106 can be comprised of one or a plurality of individual magnets.

In a related embodiment, the magnet 106 can be mounted on the crystalline material 103, for example utilizing glue, other binding materials, or common fastening mechanisms.

Similarly, the crystalline material 103 can be mounted on the target material container 104, for example utilizing glue, other binding materials, or common fastening mechanisms.

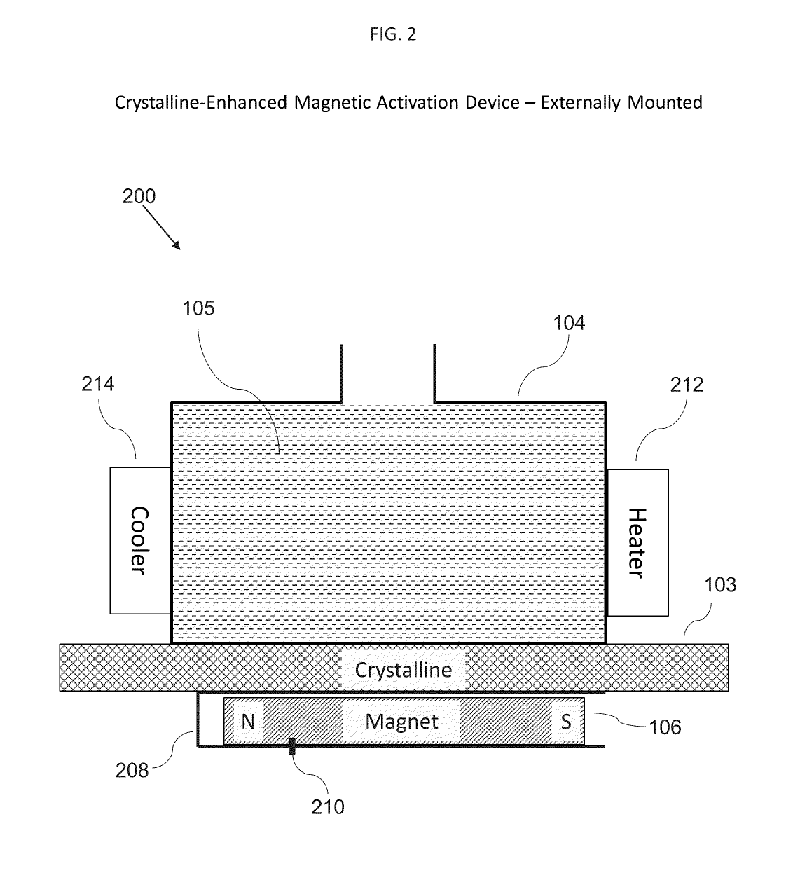

In a related embodiment, depicted in FIG. 2, the magnet 106 can be placed into a pocket or guided shaft sliding mount holder 208, with an optional lock mechanism 210 to prevent the magnet 106 from sliding out. The sliding mount holder can be made of a non-magnet metal alloy, crystalline material, plastic, or any other non-magnetic material. Such an embodiment can furthermore allow for the north and south polarity field to be conveniently reversed, by allowing a user to remove and re-install the magnet 106 in the opposite north or south direction, thereby reversing the magnetic polarity.

In a further related embodiment, the pocket can be mounted underneath a countertop or sink made of a crystalline material, so that the sink constitutes both the crystalline material 103 and the target material container 104. Such a combination of the magnet 106, housed within the pocket 208, situated immediately below the sink 104 103, is an alternative embodiment of the crystalline-enhanced magnetic activation device 200.

A sink can be any container for liquids or other household materials, and can further include a drain, and a faucet. Typical sinks are kitchen sinks, such as kitchen countertop sinks, garage sinks for cleaning or other purposes, bathroom sinks, wet bar sinks, etc.

In a further related embodiment, the crystalline-enhanced magnetic activation device can include:
a. a heating component 212, wherein the heating component 212 can heat the target material 105 contained in the target material container 104, and
b. a cooling component 214, wherein the cooling component 214 can cool the target material 105 contained in the target material container 104.

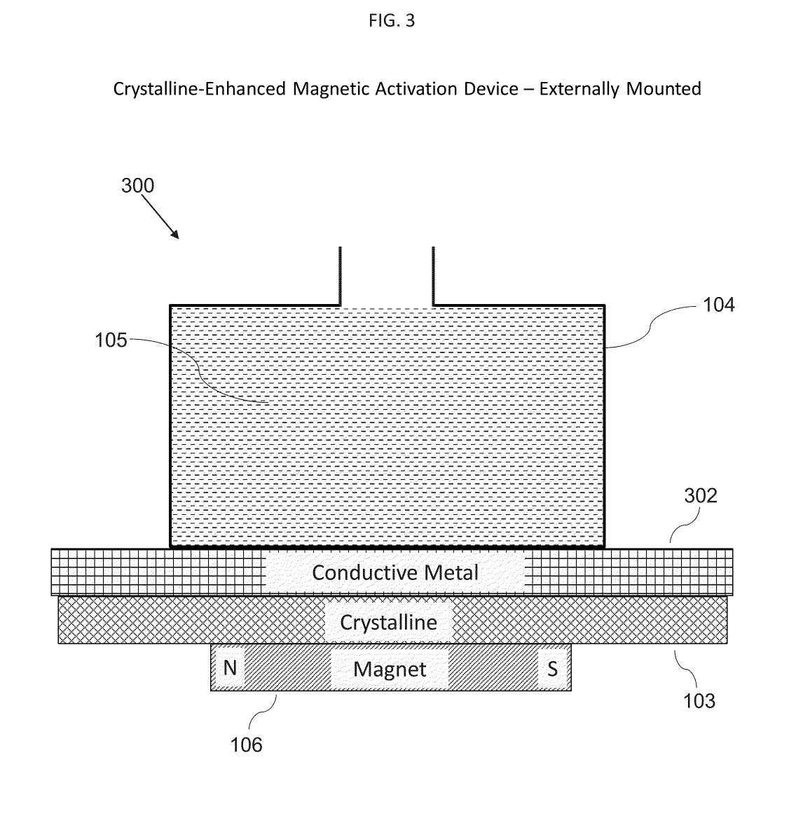

FIG. 3 shows an alternative embodiment of a crystalline-enhanced magnetic activation device 300, comprising:
a. a target material container 104,
b. a conductive metal layer 302,
c. a crystalline material 103, and
d. a magnet 106,
wherein the magnet 106 generates a magnetic field, which radiates through the crystalline material 103 and the conductive metal layer 302, whereby the target material 105, contained in the target material container 104, is activated.

The conductive metal layer 302 can be formed from a metal sheet or spiral, a coil wire formed in a multitude of geometrical shapes and sizes, made of copper, gold, silver, nickel, titanium, platinum, stainless steel or other metals or alloys, including both magnetic, para-magnetic and non-magnetic metals and alloys.

In a related embodiment, the metal layer 302 can be constructed as a composite laminate of a first metal, such as copper, gold, silver, nickel, titanium, platinum, and a second metal having a different electrode potential from the first metal. Alternatively, it can be formed from an alloy sheet containing a multitude of sheets of different alloys or metals.

In a related embodiment, the conductive metal layer 302 can be mounted between the magnet 106 and the crystalline material 103, instead of as shown in FIG. 3, between the crystalline material 103, and the target material container 104.

In a further related embodiment, the conductive metal layer 302 can be formed by plating the magnet 106 with a conductive metal layer 302, or by applying powder of a metal or alloy in a mixture of adhesive glue or other binding compound, to coat the magnet 106.

In a related embodiment, the target material container 104 can be made of any non-magnetized material in a multitude of suitable geometrical shapes and sizes. Example materials can be stainless steel, copper, gold, silver, nickel, titanium, platinum, ceramics, crystalline materials, glass, common polymers and plastics. There are no limitations to the placement of the target material container 104, as long as the magnetic field strength is maintained substantially within an effective range throughout the volume of the container. The target material container 104 can be permanently attached or separable from the magnet 106 and the crystalline material 103.

In a further related embodiment, the target material container 104 can function as the conductive metal layer 302.

In a further related embodiment, utilizing the crystalline material 103 or the conductive metal layer 302 for the target material container 104, can serve to mineralize purified water contained in the target material container 104, for enhanced flavor and taste. In such an embodiment, the crystalline material 103, can release constituent minerals to the target material water 105.

In a further related embodiment, the target material container 104 can be in the form of a fluid pipe, wherein the magnet 106, the crystalline material 103, and optionally the conductive metal layer 302, is placed substantially adjacent to the fluid pipe or inside the fluid pipe. The fluid pipe can be a copper pipe, iron pipe, plastic pipe, or a pipe made of any other suitable material.

In a related embodiment, a gradual temperature change process can be employed, to enhance the activation of material contained in the target material container 104. The gradual temperature change can be any pre-defined sequence of temperatures, to achieve the most effective activation enhancement of the target material.

In a further related embodiment, the gradual temperature change process can include:
a. raising the temperature of the target material to a pre-determined temperature, normally substantially within an effective heated temperature range of 40 to 100 degrees Celsius,
b. cooling the target material to reach equilibrium at ambient temperature over a pre-determined period of time,
c. actively cooling the target material, allowing the target material to equalize to a pre-determined temperature, normally substantially within an effective cooled temperature range of 0 to 10 degrees Celsius, whereby the organoleptic properties the target material can be enhanced.

In additional further related embodiments, the gradual temperature change process sequence can be reversed, multiplied, or recombined.

In a further related embodiment, the process of gradual temperature change, during exposure of an effective magnetic field, can be used as a method for reducing bacterial growth in a water-based solution or water-based organic material. Additionally, such embodiments can further include the use of a crystalline-enhanced magnetic field.

In further related embodiments, the method for reducing bacterial growth can be used to increase the shelf life of consumer products.

In a first example embodiment, when enhancing a target material 105, specifically a liquid, in the form of purified, reverse osmosis or distilled water, a process for crystalline-enhanced magnetic activation can include:
a. raising the temperature of the liquid to boiling temperature;
b. allowing the liquid to cool naturally to room temperature or a pre-determined ambient temperature, while placed in the magnetic field created by a magnet 106 and a crystalline material 103.

In a second example embodiment, the target material 105, exposed to a crystalline-enhanced magnetic field, subjected to a process of temperature change, can replicate the desired organoleptic properties of a natural water source. Temperature changes can be sequential, and can comprise multiple permutations. For example, the target material water can be first preheated to the boiling point, then allowed to cool naturally for a pre-determined period of time, then stabilized for an additional period of time, then frozen, and finally allowed to come to an equilibrium at room temperature.

In a third example embodiment, a process to replicate the flavor of any natural water source can include:
a. Adding filtered, purified, reverse osmosis or distilled target material water to a target material container 104;
b. Analyzing the target material water to determine the mineral composition for replication purposes, wherein the analysis is performed via standard laboratory analysis methods, for determining the composition and constituent parts of a water-based solution;
c. Adding minerals to the target material water, to replicate said naturally occurring water source, whereby the target material water is re-mineralized;
d. Heating the re-mineralized target material water to the boiling point;
e. Cooling the target material water, either ambiently or actively, to a pre-determined temperature, during a pre-determined period of time, while the target material water is exposed to the crystalline-enhanced magnetic field created by a magnet 106 and a crystalline material 103, in order to optimize the activation of flavor enhanced water for consumption or other useful purposes.

In a fourth example embodiment, a liquid pipe can be employed to activate a flowing liquid, subjected to temperature change over time, by a process including:
a. preheating the flowing liquid to a pre-determined temperature,
b. actively cooling the external surface of the pipe, for example with a fluid, radiant heat, or convective air, to a pre-determined temperature, over a sufficient length of pipe, whereby the flowing liquid, can be activated by a magnet 106, a crystalline material 103, and optionally a conductive metal layer 302, established in a multitude of possible configurations.

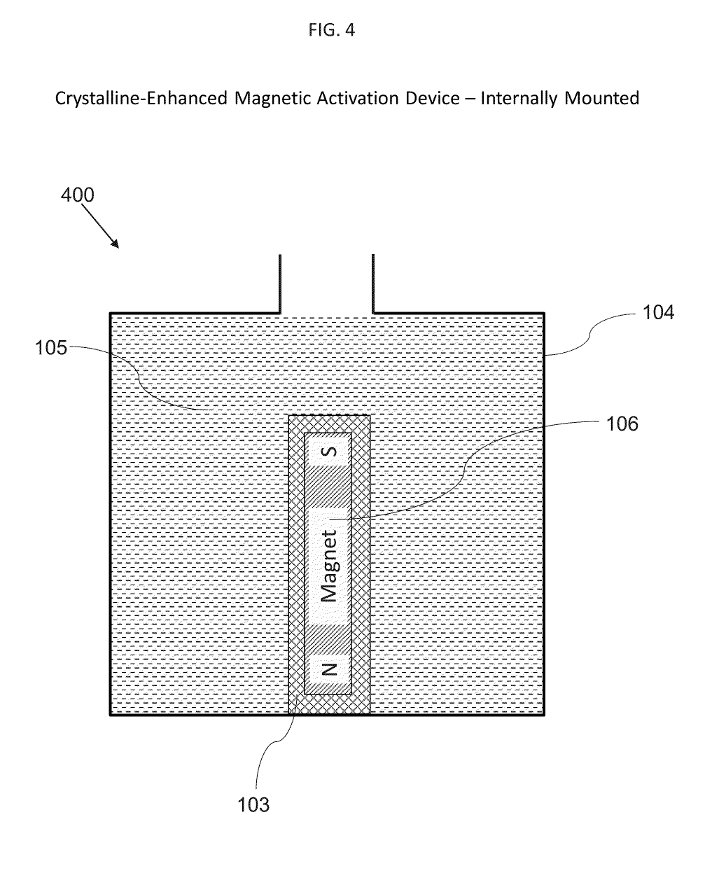

In a fifth example embodiment, as shown in FIG. 4, a magnet 106, can be encased in shell of a crystalline material 103, wherein the magnet 106 and the crystalline material 103 are contained inside the target material container 104. In a further related embodiment, a conductive metal layer 302 can further encase the magnet 106.

Here has thus been described a multitude of embodiments of the crystalline-enhanced magnetic activation device, and methods related thereto, which can be employed in numerous modes of usage.

The many features and advantages of the multitude of embodiments of the crystalline-enhanced magnetic activation device and method, are apparent from the detailed specification, and thus, it is intended by the appended claims to cover all such features and advantages of the invention, which fall within the true spirit and scope of the invention.

For example, alternative embodiments can reconfigure or combine the components of the crystalline-enhanced magnetic activation device. In an example of such an alternative configuration, the crystalline-enhanced magnetic activation device can be an integrated part of a domestic or industrial oven, such as a microwave oven or a convection oven, wherein an oven heating cavity constitutes the target material container 104, and the magnet 106, the crystalline material 103, and optionally the conductive metal layer 302, are configured as part of the oven, either inside the heating cavity, or in other parts of the oven.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A crystalline-enhanced magnetic activation device, comprising:
a. a crystalline material, and
b. a magnet;
wherein the magnet generates an effective magnetic field, which radiates through the crystalline material, whereby a substantially adjacent target material is activated.

2. The crystalline-enhanced magnetic activation device of claim 1, further comprising a target material container, wherein the magnet generates an effective magnetic field, which radiates through the crystalline material, whereby the target material, contained in the target material container, is activated.

3. The crystalline-enhanced magnetic activation device of claim 1, wherein the magnet is a permanent magnet.

4. The crystalline-enhanced magnetic activation device of claim 1, wherein the crystalline material is a natural stone.

5. The crystalline-enhanced magnetic activation device of claim 2, further comprising a conductive metal layer, wherein the magnet generates an effective magnetic field, which radiates through the crystalline material and the conductive metal layer, whereby the target material, contained in the target material container, is activated.

6. The crystalline-enhanced magnetic activation device of claim 2, further comprising a pocket, wherein the pocket is mounted on the target material container, and the magnet can be placed in the pocket.

7. The crystalline-enhanced magnetic activation device of claim 2, further comprising a heating component, wherein the heating component can heat the target material contained in the target material container to a pre-determined temperature in an effective heated temperature range.

8. The crystalline-enhanced magnetic activation device of claim 2, further comprising a cooling component, wherein the cooling component can cool the target material contained in the target material container to a pre-determined temperature in an effective cooled temperature range.

9. The crystalline-enhanced magnetic activation device of claim 2, wherein the crystalline material and the magnet are mounted internally, within the target material container.

10. The crystalline-enhanced magnetic activation device of claim 2, wherein the crystalline material and the magnet are mounted externally on the target material container.

11. The crystalline-enhanced magnetic activation device of claim 2, wherein the target material container is a sink.

12. The crystalline-enhanced magnetic activation device of claim 11, wherein the sink is the crystalline material.

13. A method for magnetic activation, wherein a target material is exposed to an effective magnetic field generated by a magnet, during an act of heating the target material to a pre-determined first temperature within an effective heated temperature range.

14. The method for magnetic activation of claim 13, wherein the effective magnetic field is a crystalline-enhanced magnetic field, generated by a magnet and a crystalline material.

15. The method for magnetic activation of claim 13, wherein the target material is water-based organic material.

16. The method for magnetic activation of claim 13, further comprising cooling the target material to a pre-determined ambient second temperature, wherein the target material reaches equilibrium over a pre-determined period of time.

17. The method for magnetic activation of claim 16, further comprising actively cooling the target material to a pre-determined third temperature within an effective cooled temperature range, wherein the target material reaches equilibrium over a pre-determined period of time.

18. The method for magnetic activation of claim 13, wherein the first temperature is the boiling point of water.

19. The method for magnetic activation of claim 16, wherein the ambient second temperature is substantially room temperature.

20. A method for crystalline-enhanced magnetic activation to replicate a natural water source, comprising:
a. adding pure water to a target material container;
b. analyzing the natural water source, to determine the mineral composition for replication purposes;
c. adding minerals to the pure water, to replicate the natural water source;
d. heating the re-mineralized pure water to a pre-determined first temperature;
e. cooling the target material water, to a pre-determined second temperature, over a pre-determined period of time, while the target material water is exposed to a crystalline-enhanced effective magnetic field, created by a magnet and a crystal, whereby the activation of flavor enhanced water is optimized for consumption and other useful purposes.

21. The method for crystalline-enhanced magnetic activation of claim 20, wherein the first temperature is the boiling point of water.

22. The method for crystalline-enhanced magnetic activation claim 20, wherein the second temperature is substantially room temperature.
